(19) United States
(12) Patent Application Publication
(10) Pub. No.: US 2026/0217135 A1
(43) Pub. Date: Jul. 30, 2026

(54) POWER MANAGEMENT SYSTEM AND METHOD

(71) Applicant: International Engine Intellectual Property Company, LLC, Lisle, IL (US)

(72) Inventors: Gary J. Gloceri, Waterford, MI (US); Ihab S. Soliman, Washington, MI (US)

(73) Assignee: International Engine Intellectual Property Company, LLC, Lisle, IL (US)

(21) Appl. No.: 19/137,351

(22) PCT Filed: Dec. 20, 2022
(86) PCT No.: PCT/US22/53445

§ 371 Date: Jun. 10, 2025

(51) Int. Cl. B60L 15/20; B60L 3/12; B60L 7/18; B60L 58/12

(52) U.S. Cl. CPC B60L 15/2018; B60L 3/12; B60L 7/18; B60L 58/12; B60L 2200/40; B60L 2240/421; B60L 2240/423; B60L 2240/54; B60L 2250/16

(57) ABSTRACT

An electric heavy vehicle having a system for managing regenerative braking power when the electric heavy vehicle descends on a downward grade by managing speed of the electric heavy vehicle comprises an electric motor, a vehicle control unit including a torque management system, a speed controller operatively connected with the torque management system, and an energy management system operatively connected with the torque management system. A battery component is disposed on the electric heavy vehicle and operatively connected with the torque management system.

### TECHNOLOGICAL FIELD

The present disclosure relates to a system and a method for managing regenerative braking power in an electric vehicle, such as a heavy truck, a trailer tractor, a bus and the like, when descending on a downward grade driving surface by managing vehicle speed. The present disclosure relates to a system and a method for managing speed of an electric vehicle utilizing an electronic controller to set a speed target and to manage torque to comply with that speed target. The present disclosure further relates to a method for reducing incidence of a battery component of an electric vehicle reaching 100% state of charge while traveling on a downward grade driving surface by managing regenerative braking power.

### BACKGROUND

In an electric vehicle, voltage is supplied from a battery to a motor. Such voltage provides for electric current that is transmitted through copper wire coils positioned on a rotating armature (i.e., a rotor) of an engine.

Speed of an electric motor refers to revolutions per minute of a rotor operatively associated with the electric motor. Torque is one factor that impacts vehicle speed. Torque, as this concept is applied to an electric vehicle motor, is the product of rotational force applied to a rotor operatively associated with the electric motor multiplied by distance through which that force travels. Torque is directly proportional to voltage of electricity transmitted from a battery to the electric motor and associated current transmitted to the rotor operatively associated with the electric motor.

Power of an electric motor is the product of torque multiplied by rotor speed. Initially, electric motor speed (i.e., speed of the rotor) increases as torque increases. However, as speed of the rotor increases, a portion of the electricity generated by the rotor may be transmitted back through the copper wire coils in the opposite direction counteracting the current supplied by the battery. This force is referred to as back-EMF (electromotive force) and is transmitted back to the battery.

Back-EMF transmitted back to the battery increases with increased rotor speed. The more back-EMF there is, the more that current traveling forward to the rotor is obstructed and, therefore, the more torque is diminished. Thus, at higher motor speeds, net current and, therefore, net or effective torque decreases due to increasing back-EMF obstructing the forward flowing current.

Back-EMF is responsible for regenerative braking in electric vehicles. Where a driver of an electric vehicle fully releases an accelerator pedal, the battery ceases to supply voltage. There is, therefore, no longer direct current being transmitted to actuate the rotor.

Where the accelerator pedal in an electric vehicle has been fully released there is no longer current propelling the rotor. The rotor will, for a period, nonetheless continue to rotate as the vehicle coasts. Such rotation is due to mechanical force transmitted back to the rotor by the vehicle's rotating wheels. The wheels will continue to rotate for some time after the accelerator pedal has been released due to momentum of the vehicle. Mechanical force generated by the rotor may then be converted into electricity. This electricity may be transmitted back to the battery. In this way, the battery will re-charge to a degree. The foregoing process is that which is referred to by those skilled in the art as regenerative braking.

Without any current flowing from the battery to the rotor, back-EMF generated by the spinning rotor may be transmitted unobstructedly back to the battery thus increasing the state of charge of the battery. This regenerative braking process can continue up to a point where all kinetic energy of the vehicle dissipates due to friction between wheels of the vehicle and a driving surface, and other external factors potentially.

Regenerative braking, therefore, involves power transfer back to a battery in an electric vehicle, thereby re-charging the battery and extending the range of the vehicle. Regenerative braking occurs automatically in electric vehicles upon full or partial release of the accelerator pedal.

If, however, a battery in an electric vehicle is fully or nearly fully charged (i.e., 100% state of charge), then it may no longer be possible to dissipate kinetic energy of the electric vehicle through regenerative braking. Under such circumstances, wheel braking may be needed to decelerate or maintain the speed of the vehicle. This scenario is particularly problematic in electric heavy trucks because wheel brakes on an electric heavy truck may not be sized to control vehicle speed effectively when traveling on a long downward grade driving surface.

### SUMMARY

An electric heavy vehicle having a system for managing regenerative braking power when the electric heavy vehicle descends on a downward grade by managing speed of the electric heavy vehicle comprises an electric motor, a vehicle control unit including a torque management system, a speed controller operatively connected with the torque management system, and an energy management system operatively connected with the torque management system. A battery component is disposed on the electric heavy vehicle and operatively connected with the torque management system.

### BRIEF DESCRIPTION OF THE DRAWING

FIG. 1 is a diagram depicting an energy management system for an electric vehicle described herein.

### DETAILED DESCRIPTION

The following disclosure concerns an electric vehicle, such as a heavy truck and the like, including embodiments of systems and methods for managing regenerative braking power when the electric vehicle descends on a downward grade driving surface by managing speed of the electric vehicle. The present disclosure further concerns an electric vehicle including embodiments of methods for substantially reducing incidence of a battery component of an electric vehicle reaching 100% state of charge while traveling on a downward grade driving surface by managing regenerative braking power.

For purposes of clearly describing the components, features, and method steps discussed throughout this disclosure, some frequently used terms will now be defined. The term “electric motor,” as it is used throughout this disclosure, includes both direct current (DC) and alternating current (AC) electric vehicle motors, unless otherwise indicated. The term “electric motor” should be understood to include all components commonly found in a current electric vehicle DC or AC. Such components may include, among others, a rotor, a shaft, and a stator. Where a system according to the present disclosure comprises an AC electric motor, the term “electric motor” includes an inverter as well. The term “electric heavy truck,” as it is used throughout this disclosure, means a truck comprising an electric motor and having a weight limit of at least 20,000 pounds.

An electric heavy truck may require power dissipation to control speed of the electric heavy truck on a downward grade driving surface. Depicted in the graph below is an illustration of an approximate amount of power used by an electric heavy truck loaded to 80,000 pounds to maintain substantially constant speed when traveling on a 6% downward grade driving surface:

As reflected in GRAPH 1, as speed of the electric heavy truck increases, increased power, and therefore an increased amount of negative torque, may be needed to maintain substantially constant speed of the electric heavy truck on a 6% downward grade driving surface.

In an electric vehicle, such power dissipation may be enabled through regenerative braking. As state of charge of a battery of the electric vehicle increases, ability of that battery to accept power is reduced. A common battery can accept for 30 seconds amounts of power set forth in the table below at states of charge indicated.

TABLE 1
30 s Charge Pack, kW

| | % SOC | | | | | | | | | | |
|---|---|---|---|---|---|---|---|---|---|---|---|
| ° C. | 0 | 10 | 20 | 30 | 40 | 50 | 60 | 70 | 80 | 90 | 100 |
| 25 | 581.0 | 664.4 | 693.0 | 712.9 | 623.9 | 566.1 | 363.4 | 334.9 | 229.0 | 155.2 | 0.0 |

As reflected in TABLE 1, as a battery reaches increased states of charge, ability of the battery to accept power that is available through regenerative braking decreases.

A battery in an electric vehicle may accept an increased amount of power for a shorter period of time. The table below sets forth, for the same battery as above, maximum power acceptance for ten second periods for the states of charge indicated.

TABLE 2
10 s Charge Pack, kW

| | % SOC | | | | | | | | | | |
|---|---|---|---|---|---|---|---|---|---|---|---|
| ° C. | 0 | 10 | 20 | 30 | 40 | 50 | 60 | 70 | 80 | 90 | 100 |
| 25 | 1014.0 | 1014.0 | 1014.0 | 792.1 | 808.8 | 589.7 | 363.4 | 372.1 | 381.6 | 388.0 | 0.0 |

As an electric heavy truck may not have a retarder as does a truck having an internal combustion engine, and wheel brakes for electric heavy truck may not be sized to control speed of the electric heavy truck on large downward grade driving surface, and, while an electric heavy truck may decelerate through regenerative braking, once a battery associated with the electric heavy truck has reached maximum state of charge, wheel brakes on the electric heavy truck may comprise a sole way to decelerate the electric heavy truck. As noted, however, wheel brakes in an electric heavy truck may not be sized to dissipate energy sufficiently when traveling on a downward grade driving surface, thereby leading to insufficient ability to manage speed of the electric heavy truck. These issues may be present with an electric vehicle other than an electric heavy truck. Embodiments disclosed herein may be used in that electric vehicle other than an electric heavy truck, sometimes with appropriate modification.

Another negative effect when a battery in an electric heavy truck reaches maximum state of charge when traveling on a downward grade driving surface may be overcharging of the battery. Such overcharging may cause exceeding of thermal limits of cells of the battery and, ultimately, battery failure potentially.

Regenerative braking power management may be realized, according to embodiments disclosed herein, by managing torque in a way that substantially avoids a scenario as discussed above where a battery in an electric heavy truck reaches a 100% state of charge and, therefore, can no longer accept energy generated through regenerative braking. By reducing incidence of a battery in an electric heavy truck reaching 100% state of charge, embodiments described herein enable a driver of an electric heavy truck to maintain substantially constant vehicle speed when traveling on a downward grade driving surface.

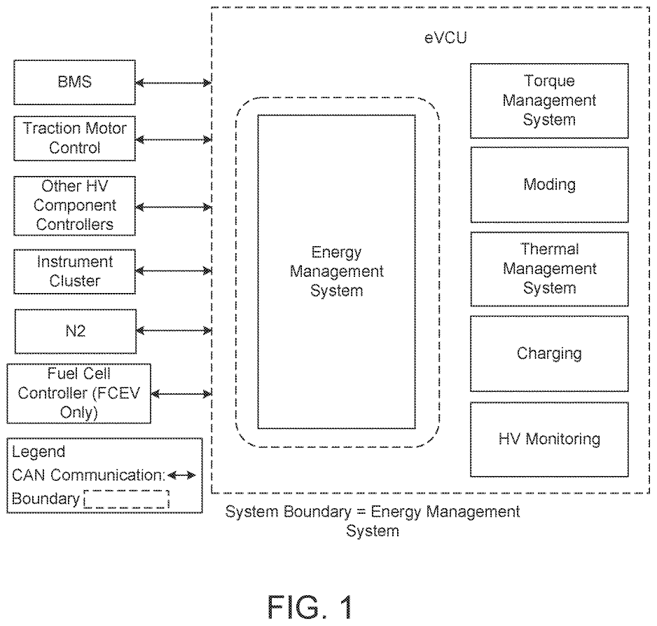

Referring to FIG. 1, an energy management system for an electric heavy truck including embodiments of systems and methods for managing regenerative braking power when descending on a downward grade driving surface by managing speed of the electric heavy truck is shown. An electric heavy truck may comprise a Vehicle Control Unit (VCU) disposed on the electric heavy truck. The VCU may comprise a Torque Management System (TMS) and an Energy Management System (EMS). The TMS and the EMS may be communicatively and operatively connected with each other.

In some conventional VCUs, the TMS is bound only by power limits signaled by the EMS. Power is the product of torque multiplied by speed. Thus, for a given speed, a TMS may modify its torque request in a manner so that power output is maintained within a power limit signaled by the EMS.

Where a driver is applying an accelerator pedal, and the power limit has been met, the TMS may reduce the torque command in order to remain within the power limit signaled by the EMS. Where, however, a vehicle is traveling on a downward grade driving surface, due to force of gravity acting on the vehicle as well as a negative torque may be needed in order to maintain substantially constant speed of the vehicle. According to embodiments of the present disclosure, therefore, a TMS may request negative torque when the electric heavy truck is descending on a downward grade driving surface.

VCUs of systems as described herein may comprise a speed controller for identifying a maximum speed. Such speed controller may be communicatively and operatively connected with the TMS. Speed controllers of the present disclosure may transmit a signal to the TMS identifying this maximum speed. TMSs of the present disclosure may then calculate a target torque that abides by both this maximum speed, as well as by a power limit signaled by the EMS. By substantially maintaining a torque request within both the speed and power limits, back-EMF may be managed effectively when traveling on a downward grade driving surface. Effective management of back-EMF may reduce an instance where an electric heavy truck traveling on a downward grade driving surface loses regenerative braking ability due to the battery on the electric heavy truck reaching maximum state of charge.

Thus, according to embodiments described herein, an electric heavy truck, upon encountering a downward grade driving surface, may actively decelerate by requesting a pre-determined level of negative torque that abides by the power limit transmitted by the EMS and also abides by the speed limit transmitted by speed controller as described herein. In this way, systems and methods of the present disclosure may effectively manage regenerative braking power, thereby allowing for an electric heavy truck to maintain substantially constant speed when traveling on a downward grade driving surface by substantially avoiding 100% state of charge of the battery on the electric heavy vehicle.

Embodiments may comprise an electric motor disposed on the electric heavy vehicle. The electric motor may be communicatively and operatively connected with a TMS. The electric motor may be a DC motor or an AC motor. Those of skill in the art will readily appreciate the components of contemporary DC and AC electric motors intended for use in an electric vehicle, including an electric heavy truck.

VCUs of the present disclosure may comprise an EMS. The EMS may be communicatively and operatively connected with the TMS. The EMS may transmit a signal to the TMS identifying a maximum power output by which to abide. In an embodiment, speed of an electric heavy truck may decrease in a manner that corresponds to decreases in maximum power output for the electric motor.

Embodiments may comprise a battery component disposed on the electric heavy vehicle. The battery component may be communicatively and operatively connected with the TMS. The battery component may transmit a signal to the TMS identifying state of charge of the battery component and maximum power acceptance of the battery component. In an embodiment, when maximum power of the battery component acceptance decreases, there may be a corresponding decrease in regenerative braking power.

Embodiments may comprise a speed controller. The speed controller may calculate a maximum speed of the electric heavy vehicle such that corresponding back-EMF may be effectively maintained in a manner that substantially reduces overcharging the battery.

TMSs of the present disclosure may calculate another negative, target torque value upon receipt of a signal transmitted by at least one of the speed controller, the EMS, and the battery component. TMSs of the present disclosure may transmit a command signal to the electric motor submitting such negative target torque value.

Embodiments may further comprise a set of sensors communicatively and operatively connected with the speed controller. The sensors may determine slope of a surface on which the electric heavy vehicle is traveling. The sensors may transmit a signal to the speed controller identifying changes in slope of the surface. The sensors may detect downward grade driving surfaces and may transmit information concerning degree of downward grade driving surface to the speed controller.

Embodiments may further comprise a display component communicatively and operatively connected with the TMS. Such display component may comprise an electromagnetic wave emitter that emits an electromagnetic wave to a driver of an electric heavy truck when the TMS requests negative torque while traveling on a downward grade driving surface. Embodiments may further comprise an auditory component. Such auditory component may comprise a longitudinal wave emitter configurable to emit a longitudinal wave when the TMS requests negative torque while traveling on a downward grade driving surface. According to such embodiments, nature of the electromagnetic wave and associated longitudinal wave may change in a manner that corresponds to an amount of negative torque requested by the TMS.

Embodiments may be utilized in connection with methods for managing regenerative braking power in an electric heavy truck when the truck descends a downward grade driving surface by managing vehicle speed. According to such embodiments, the speed controller may transmit a signal to a TMS identifying a maximum motor speed. An EMS may transmit a signal to the TMS identifying a maximum power output for the motor of the electric heavy truck. The battery component may transmit a signal to the TMS identifying state of charge of the battery component and maximum power acceptance of the battery component.

In an embodiment, upon receipt of a signal transmitted by at least one of the speed controller, the EMS, and the battery component, the TMS may calculate another negative, target torque value. Upon calculation of the another target torque value, the TMS may transmit a command signal to the electric motor submitting the target negative torque value.

In an embodiment, maximum power acceptance of the battery component may decrease as state of charge of the battery component increases.

In an embodiment, maximum motor speed may decrease as the state of charge of the battery component increases.

In an embodiment, maximum power output for the electric motor may decrease as state of charge of the battery component increases.

In an embodiment, speed of an electric heavy truck may decrease in a manner that corresponds to a decrease in maximum power output for the electric motor.

In an embodiment, regenerative braking power may decrease in a manner that correlates with a decrease in maximum power acceptance of the battery component.

In an embodiment, such methods may further comprise providing a set of sensors disposed on the electric vehicle communicatively and operatively connected with the speed controller. The sensors may determine slope of a surface on which the electric heavy truck is traveling. The sensors may transmit a signal to the speed controller identifying changes in slope of the surface. The sensors may detect downward grade driving surfaces and may transmit information concerning the degree of downward grade driving surface to the speed controller. According to such embodiments, the speed controller may determine an appropriate maximum speed taking into consideration data received from the sensors.

Embodiments disclosed herein may be utilized in connection with methods for substantially eliminating incidence of a battery component of an electric heavy truck reaching 100% state of charge while traveling on a downward grade driving surface by managing regenerative braking power. According to such embodiments, the display component may comprise an electromagnetic wave emitter that emits an electromagnetic wave when state of charge of the battery component exceeds 80%.

What is claimed is:

1. An electric heavy vehicle having a system for managing regenerative braking power when the electric heavy vehicle descends on a downward grade by managing speed of the electric heavy vehicle, the system comprising:
an electric motor disposed on the electric heavy vehicle;
a vehicle control unit disposed on the electric heavy vehicle and operatively connected with the electric motor, wherein the vehicle control unit comprises:
a torque management system,
a speed controller operatively connected with the torque management system, and
an energy management system operatively connected with the torque management system; and
battery component disposed on the electric heavy vehicle and operatively connected with the torque management system.

2. The electric heavy vehicle of claim 1 wherein the electric motor is a DC electric motor.

3. The electric heavy vehicle of claim 1 wherein the electric motor is an AC electric motor.

4. The electric heavy vehicle of claim 1 further comprising:
a set of sensors disposed on the electric heavy vehicle and operatively connected with the speed controller.

5. The electric heavy vehicle of claim 1 further comprising:
a display component disposed on the electric heavy vehicle and operatively connected with the torque management system.

6. The electric heavy vehicle of claim 5 wherein the display component comprises an electromagnetic wave emitter disposed on the electric heavy vehicle operatively connected with the torque management system.

7. The electric heavy vehicle of claim 5, further comprising:
an auditory component comprising a longitudinal wave emitter disposed on the electric heavy vehicle.
